(19) United States
(12) Patent Application Publication
(10) Pub. No.: US 2022/0010755 A1
(43) Pub. Date: Jan. 13, 2022

(54) AIR INTAKE APPARATUS OF INTERNAL COMBUSTION ENGINE

(71) Applicant: AISIN CORPORATION, Kariya (JP)

(72) Inventors: Hideto YANO, Kariya-shi (JP); Tomohiro YAMAGUCHI, Kariya-shi (JP); Masato ISHII, Kariya-shi (JP)

(73) Assignee: AISIN CORPORATION, Kariya (JP)

(21) Appl. No.: 17/355,836

(22) Filed: Jun. 23, 2021

(30) Foreign Application Priority Data
Jul. 13, 2020 (JP) 2020-119871

(51) Int. Cl. F02M 31/125; F02M 35/10

(52) U.S. Cl. CPC F02M 31/125; F02M 35/10216

(57) ABSTRACT

An air intake apparatus of an internal combustion engine includes a port portion into which fuel injected form an injection opening of an injector is introduced, an intake passage provided at an inner side of the port portion to flow an air-fuel mixture including the fuel and air, the air-fuel mixture being supplied to a cylinder provided at the internal combustion engine, and a port heater provided along an inner surface of the port portion to vaporize the fuel introduced into the intake passage. The port heater includes regions with different heat generation amounts from each other in accordance with a distribution of an adhesion amount of the fuel injected from the injection opening of the injector to the inner surface of the port portion.

### CROSS REFERENCE TO RELATED APPLICATIONS

This application is based on and claims priority under 35 U.S.C. § 119 to Japanese Patent Application 2020-119871, filed on Jul. 13, 2020, the entire content of which is incorporated herein by reference.

### TECHNICAL FIELD

This disclosure generally relates to an air intake apparatus of an internal combustion engine.

### BACKGROUND DISCUSSION

A known air intake apparatus of an internal combustion engine includes a port into which fuel injected from an injection opening of an injector is introduced.

For example, JP2008-121569A (which is hereinafter referred to as Reference 1) discloses an air intake port structure of an internal combustion engine (an air intake apparatus of an internal combustion engine) including a liner member (a port) into which fuel injected from an injection opening of an injector is introduced. The aforementioned air intake port structure includes a heating wire wound and fixed at the liner portion. The heating wire is wound at the liner member at even intervals.

According to Reference 1, the heating wire wound at even intervals heats the entire liner member uniformly. This causes the fuel that is injected from the injector to adhere to an inner surface of the liner member to be vaporized. It is known that the fuel injected from an injector typically has a thick part and a thin part.

According to the intake port structure of Reference 1, the inner surface of the liner member may have a portion with relatively a large amount of fuel, a portion with relatively a small amount of fuel, and a portion with no fuel when the fuel is infected from the injector to adhere to the inner surface, which is caused by the thick part and the thin part of the fuel injected from the injector. The liner member of the aforementioned intake port structure is entirely and evenly heated by the heating wire, so that the portion with the small amount of fuel and the portion with no fuel of the inner surface may be heated with the same heat level as the portion with the large amount of fuel. Additionally, in order to securely vaporize the fuel to adhere to the inner surface of the port member, the heating wire should entirely heat the liner member with a heat level conforming to the portion with the large amount of fuel, which may lead to waste of heat of the heating wire. The fuel may not be securely vaporized while excessive power consumption of the heating wire (a port heater) is retrained.

A need thus exists for an air intake apparatus of an internal combustion engine which is not susceptible to the drawback mentioned above.

### SUMMARY

According to an aspect of this disclosure, an air intake apparatus of an internal combustion engine includes a port portion into which fuel injected form an injection opening of an injector is introduced, an intake passage provided at an inner side of the port portion to flow an air-fuel mixture including the fuel and air, the air-fuel mixture being supplied to a cylinder provided at the internal combustion engine, and a port heater provided along an inner surface of the port portion to vaporize the fuel introduced into the intake passage. The port heater includes regions with different heat generation amounts from each other in accordance with a distribution of an adhesion amount of the fuel injected from the injection opening of the injector to the inner surface of the port portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view of an intake port mounted at a cylinder head according to an embodiment disclosed here;

FIG. 2 is a perspective view of the intake port according to the embodiment;

FIG. 3 is an exploded perspective view of the intake port according to the embodiment;

FIG. 4 is a cross-sectional view of the intake port in a direction orthogonal to an A direction according to the embodiment;

FIG. 5 is a cross-sectional view taken along line V-V in FIG. 4 and a block diagram illustrating a temperature sensor and a controller;

FIG. 6 is an exploded perspective view of a port heater according to the embodiment;

FIG. 7 is a schematic view illustrating a distribution of fuel adhesion to the intake port according to the embodiment;

FIG. 8 is a schematic view illustrating a distribution of fuel adhesion to the port heater according to the embodiment;

FIG. 9 is a plan view illustrating a first heat generation region and a second heat generation region of the port heater according to the embodiment;

FIG. 10 is a plan view illustrating a heat generation distribution at the first heat generation region and the second heat generation region of the port heater according to the embodiment;

FIG. 11 is a graph illustrating a relation between a liquid film thickness of fuel that adheres to the intake port and a distance according to the embodiment;

FIG. 12 is an enlarged view of a K1 portion illustrated in FIG. 10;

FIG. 13 is an enlarged view of a K2 portion illustrated in FIG. 10; and

FIG. 14 is a plan view illustrating a port heater according to a modified example.

### DETAILED DESCRIPTION

An embodiment is explained with reference to the attached drawings.

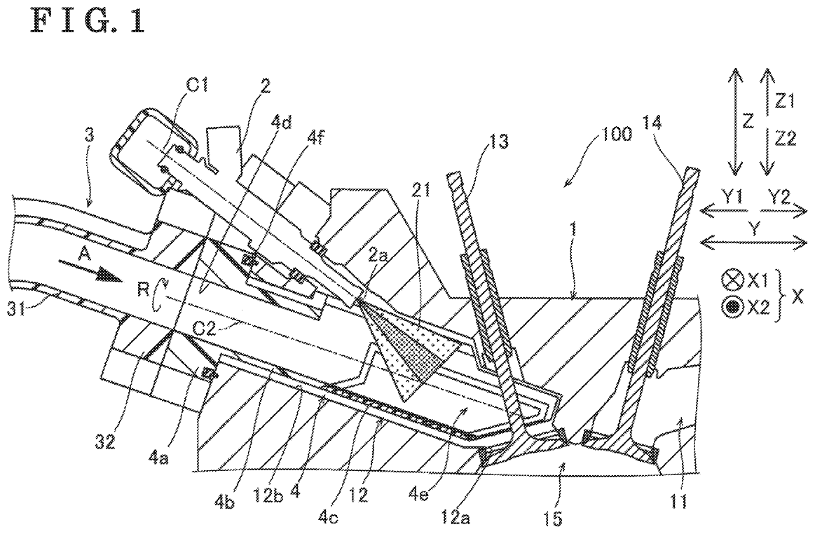

An engine 100 for a vehicle, serving as an internal combustion engine, includes a cylinder head 1 as illustrated in FIG. 1 fixed to a cylinder block that is positioned at a Z2 side of the cylinder head 1. The cylinder head 1 includes plural exhaust ports 11 and plural inlet ports 12 connected to combustion chambers 15. The cylinder head 1 also includes plural intake valves 13 and plural exhaust valves 14. The intake valves 13 are configured to open and close corresponding intake openings 12a through which the combustion chambers 15 and the plural inlet ports 12 are connected to one another. The exhaust valves 14 are configured to open and close corresponding openings through which the combustion chambers 15 and the plural exhaust ports 11 are connected to one another.

An upstream and a downstream in the disclosure are defined on a basis of a flow of air flowing through each inlet port 12 and suctioned into the combustion chamber 15. That is, the upstream and the downstream are based on an A direction (an intake airflow direction) in FIG. 1. In a state where the engine 100 including plural cylinders is mounted at a vehicle (in FIG. 1, a single cylinder is illustrated), a direction where the cylinders extend is defined to be a Z direction corresponding to up and down direction. The Z direction includes a Z1 side corresponding to an upper side and a Z2 side corresponding to a lower side. A direction where the plural cylinders are arranged next to one another in the vehicle is defined to be an X direction corresponding to front and rear direction. The X direction includes an X1 side corresponding to a front side and an X2 side corresponding to a rear side. A direction orthogonal to the Z direction and the X direction is defined to be a Y direction corresponding to left and right direction. The Y direction includes a Y1 side corresponding to a right side and a Y2 side corresponding to a left side.

Each inlet port 12 includes the intake opening 12a through which the inlet port 12 is connected to the combustion chamber 15. A portion of the inlet port 12 in the vicinity of the intake opening 12a extends along the Y direction (i.e., substantially a horizontal direction). The inlet port 12 may be constructed to entirely incline to the Z2 side towards the Y direction from an opening at the Y1 side to the intake opening 12a.

The engine 100 is configured to supply air-fuel mixture including air and fuel 21 into the combustion chamber 15 of a cylinder. Specifically, the engine 100 includes an injector 2, an intake manifold 3, an intake port 4 serving as an air intake apparatus of an internal combustion engine, a temperature sensor 5, and a controller 6.

The injector 2 is constructed to spray or inject the fuel 21 from the upstream side to the downstream side in the A direction. The injector 2 sprays the fuel 21 in the form of mist to air flowing towards the combustion chamber 15. The injector 2 is mounted at the cylinder head 1 in a manner to incline to the Z1 side (i.e., upper side) relative to the extending direction of the intake port 4. A center axis line C1 of the injector 2 thus inclines to the Z1 side relative to the extending direction of the intake port 4. The center axis line C1 of the injector 2 extends towards a center of a surface of the intake valve 13 opposite from a surface facing the combustion chamber 15.

The injector 2 includes an injection opening 2a through which the fuel 21 is sprayed and spread circumferentially towards the combustion chamber 15 (i.e., towards the downstream side). The fuel 21 sprayed from the injector 2 includes higher density in the form of particles at a center than an outer side. Specifically, the fuel 21 sprayed from the injector 2 is thick at a center and is thinner towards an outer side. The fuel 21 is gasoline, gas fuel, or ethanol, for example. The engine 100 is a port injection engine where the fuel 21 is injected into the inlet port 12.

The intake manifold 3 is constructed to supply air into the combustion chambers 15.

The intake manifold 3 that is made of resin includes a surge tank, an intake pipe 31 (intake pipes), and an attachment portion 32. The surge tank temporarily stores air. In the intake manifold 3, the surge tank is arranged at an upstream end portion in the A direction. The intake pipe 31 flows air along a passage formed therein. The intake pipe 31 is positioned at the downstream side than the surge tank to connect between the surge tank and the attachment portion 32. The attachment portion 32 forms a flange where a fastening member is inserted to be positioned for fixing the intake manifold 3 to the cylinder head 1. The intake manifold 3 is fixed to the cylinder head 1 via the attachment portion 32 accordingly.

The intake port 4 is a resin member that restrains heat transmission from the cylinder head 1 to air supplied to the combustion chamber 15 from the intake manifold 3. The engine 100 has a heat insulation port structure where heat from the cylinder head 1 is prevented by the resinous intake port 4 that is arranged within the inlet port 12 to extend therethrough.

As illustrated in FIGS. 1 to 3, the intake port 4 includes a mounting portion 4a, plural (four, in the embodiment) outer port members 4b, plural (four, in the embodiment) inner port members 4c, plural (four, in the embodiment) intake passages 4d, and plural (four, in the embodiment) port heaters 4e. The outer port member 4b serves as an example of a port portion.

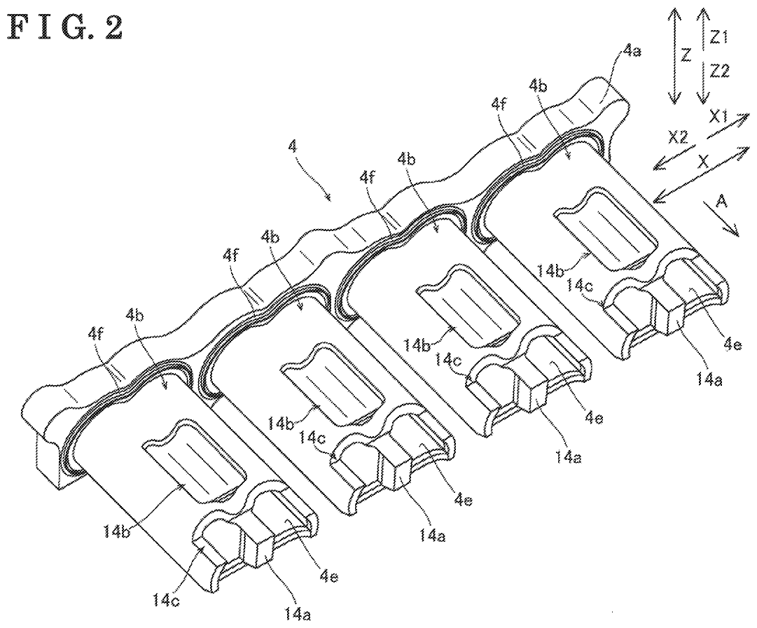

As illustrated in FIGS. 1 and 2, the mounting portion 4a of the intake port 4 is configured to fix the intake port 4 together with the intake manifold 3 to the cylinder head 1. The mounting portion 4a of the intake port 4 is arranged between the attachment portion 32 of the intake manifold 3 and a peripheral portion of an inlet opening of the inlet port 12 of the cylinder head 1. The mounting portion 4a forms a flange where the fastening member for fixing the intake manifold 3 to the cylinder head 1 is inserted to be positioned.

Gaskets 4f are disposed at the mounting portion 4a of the intake port 4. Specifically, the gaskets 4f are arranged at the mounting portion 4a to be opposed to the respective inlet ports 12. Each gasket 4f is provided to restrain intrusion of a foreign matter such as water, for example, into the inlet port 12 from through a gap between the mounting portion 4a and the peripheral portion of the inlet opening of the inlet port 12.

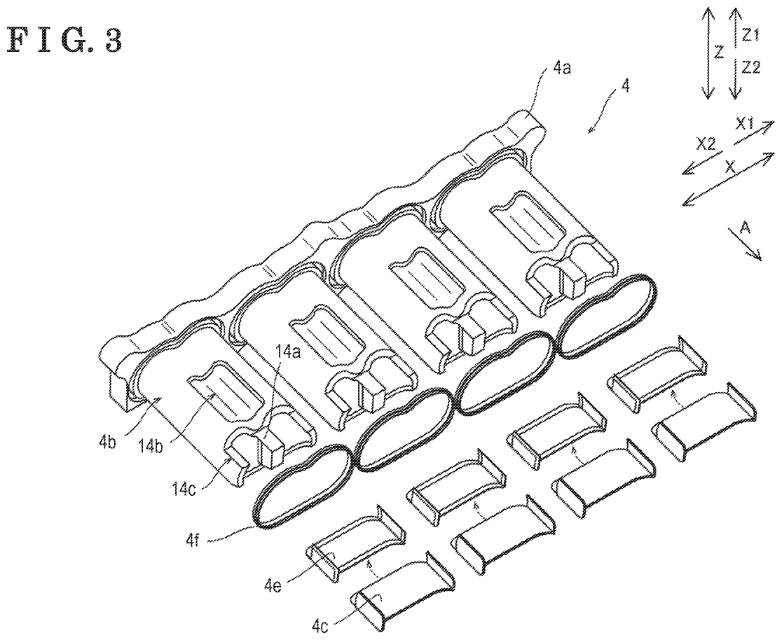

Next, the outer port members 4b are explained with reference to FIGS. 2 and 3. The constructions of the plural (four) outer port members 4b are the same, so that one of the outer port members 4b arranged at the end in the X2 direction is explained. In the same manner, the inner port member 4c, the intake passage 4d, and the port heater 4e arranged at the end in the X2 direction are explained.

As illustrated in FIG. 1, the outer port member 4b is constructed to have heat resistance against heat transmitted from the cylinder head 1 and heat from the combustion chamber 15. Specifically, the outer port member 4b includes non-formed resin material. The outer port member 4b is made of polyamide 66 with heat resistance, for example. Change in physical property such as dissolution, for example, caused by heat transmitted from the cylinder head 1 and heat from the combustion chamber 15 at a region where the outer port member 4b is arranged is thus restrained.

The outer port member 4b is positioned to extend through the inlet port 12 within the cylinder head 1 at which the injector 2 is mounted. The outer port member 4b faces an inner surface 12b of the inlet port 12. The outer port member 4b has the length so as to extend from an upstream end of the inlet port 12 to the vicinity of a downstream end thereof in the A direction. The heat transmission from the cylinder head 1 to air flowing through the intake passage 4d is thus restrained at a region from the upstream end to the downstream end of the inlet port 12.

The outer port member 4b includes a partition wall 14a, an injector opening 14b, and a valve opening 14c as illustrated in FIGS. 1 and 2.

The partition wall 14a includes a function to separate air flowing through the intake passage 4d based on the number of intake valves 13 provided at the single inlet port 12. In a case where two intake valves 13 are provided at one inlet port 12, the partition wall 14a is configured to divide air flowing through the intake passage 4d into two. The injector opening 14b is provided to introduce the fuel 21 injected from the injector 2 that supplies the fuel 21 to the inlet port 12. The valve opening 14c is provided to inhibit an interference between the intake valve 13 and the outer port member 4b.

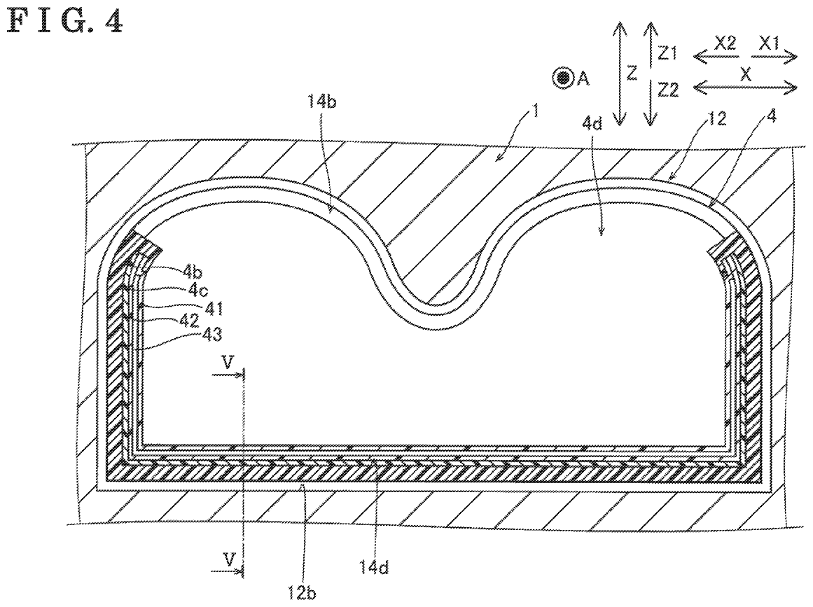

As illustrated in FIG. 4, the outer port member 4b has substantially a C-shape as viewed from the downstream side in the A direction. The outer port member 4b includes an external surface conforming to (i.e., extending along) the inner surface 12b of the inlet port 12 in a cross-section orthogonal to the A direction.

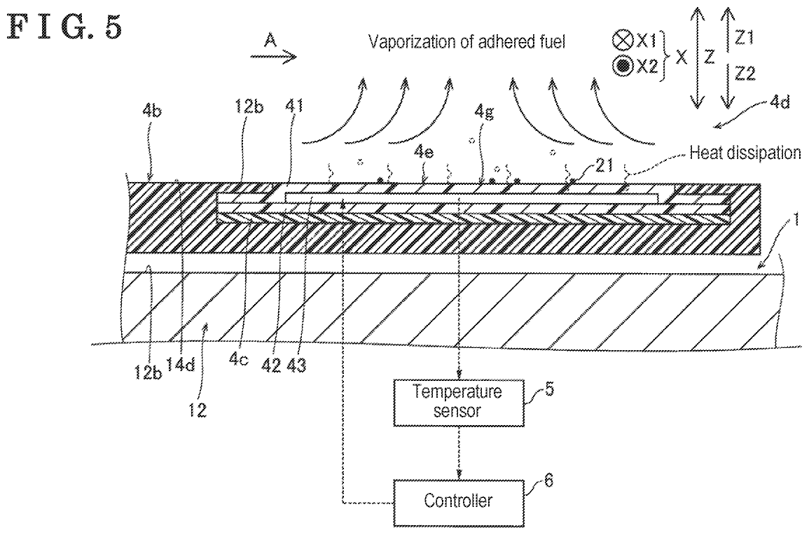

As illustrated in FIGS. 4 and 5, the inner port member 4c functions as a heat insulation member that restrains heat transmission from the port heater 4e. The inner port member 4c includes a formed resin material. The inner port member 4c is made of polyamide that is foam-molded. The inner port member 4c is disposed at the inner side of the outer port member 4b. Specifically, the inner port member 4c is embedded in the outer port member 4b. The inner port member 4c is arranged to directly contact with an inner surface 14d of the outer port member 4b.

The inner port member 4c has substantially a C-shape as viewed from the downstream side in the A direction. The inner port member 4c thus includes the configuration conforming to the configuration of the outer port member 4b as viewed from the downstream side in the A direction.

The intake passage 4d is formed at an inner side of the outer port member 4b to flow air-fuel mixture including air and the fuel 21 supplied to the cylinder. The intake passage 4d is an inner void of the outer port member 4b and the inner port member 4c. The intake passage 4d extends through the outer port member 4b and the inner port member 4c in the A direction. The fuel 21 injected from the injection opening 2a of the injector 2 is introduced to the outer port member 4b accordingly.

The port heater 4e is configured to forcedly heat and vaporize (evaporate) the fuel 21 that has filed to vaporize and adhered to an inner surface 4g of the intake port 4 even when a peripheral temperature is low. The port heater 4e is provided along the inner surface 14d of the outer port member 4b and the inner surface of the inner port member 4c to heat and vaporize the fuel 21 introduced into the intake passage 4d. The port heater 4e serving as a heater is thus used to vaporize the fuel 21 introduced into the intake passage 4d from the injector 2.

The port heater 4e is arranged at a portion of the outer port member 4b, the portion being inserted to be positioned within the inlet port 12. Specifically, the port heater 4e is arranged at an end portion of the outer port member 4b, i.e., at a downstream end in the A direction. The port heater 4e is also arranged at the Z2 side than the center axis line C1 with reference to the Z direction.

The port heater 4e is constructed to securely apply heat to the fuel 21 that has spread over the inner surface 4g of the intake port 4 and adhered thereto. Specifically, the port heater 4e is arranged to substantially entirely extend over the inner surface 14d of the outer port member 4b and the inner surface of the inner port member 4c in a cross-section orthogonal to the A direction. The port heater 4e has a curved form or a bent form along the inner surface 14d of the outer port member 4b and the inner surface of the inner port member 4c.

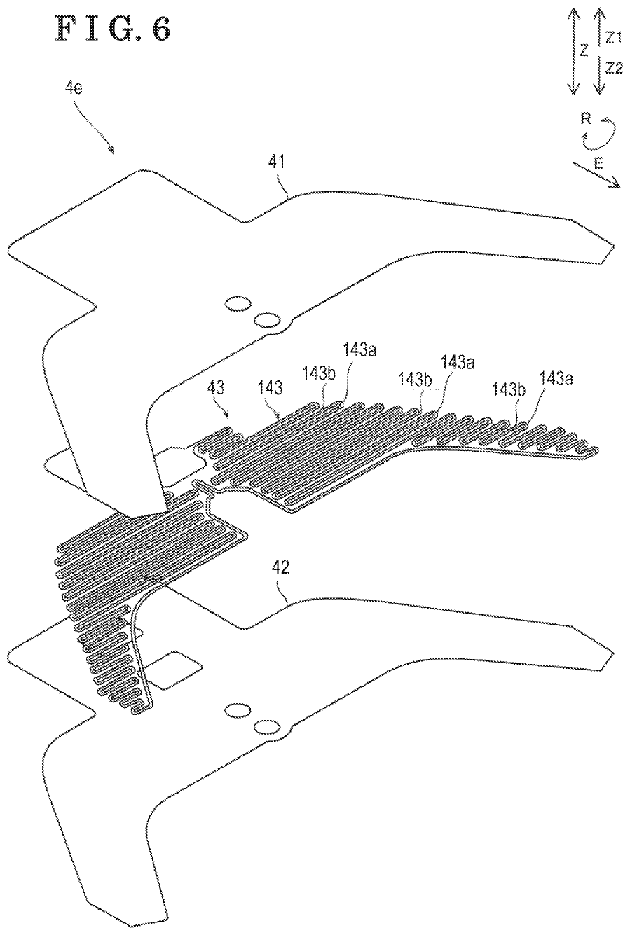

As illustrated in FIGS. 5 and 6, the port heater 4e is formed into a film that is able to bend and curve. The port heater 4e is a planar heater.

The port heater 4e includes a first protective sheet 41, a second protective sheet 42, and a heat generator 43. The port heater 4e has a three-layer structure where the heat generator 43 is sandwiched between the first protective sheet 41 and the second protective sheet 42. The first protective sheet 41, the heat generator 43, and the second protective sheet 42 are laminated in the aforementioned order from the Z1 side to constitute the port heater 4e.

The first protective sheet 41 and the second protective sheet 42 are provided as insulation from electric current flowing through the port heater 4e. The first protective sheet 41 that is disposed at the Z1 side (opposed to the intake passage 4d) covers the heat generator 43 from the Z1 side. The second protective sheet 42 that is disposed at the Z2 side (opposed to the inner port member 4c) covers the heat generator 43 from the Z2 side.

As illustrated in FIGS. 5 and 6, the first protective sheet 41 and the second protective sheet 42 are entirely provided in a cross-section orthogonal to the A direction of the intake port 4. The first protective sheet 41 and the second protective sheet 42 are arranged conforming to the configurations of the inner surface 14d of the outer port member 4b and the inner surface of the inner port member 4c. Specifically, each of the first protective sheet 41 and the second protective sheet 42 is formed substantially in a Y-shape as viewed from the Z1 side. Each of the first protective sheet 41 and the second protective sheet 42 includes a cutout cut (concaved) in a direction opposite to the A direction from an end portion in the A direction.

Each of the first protective sheet 41 and the second protective sheet 42 is made from a material so as to be easily follow the configurations of the inner surface 14d of the outer port member 4b and the inner surface of the inner port member 4c. Specifically, each of the first protective sheet 41 and the second protective sheet 42 is made from a resinous film. The first protective sheet 41 and the second protective sheet 42 are desirably made from a resinous material including heat resistance, oil resistance, and chemical resistance. For example, the first protective sheet 41 and the second protective sheet 42 may be made of polyimide.

The first protective sheet 41 is constructed to easily receive heat from the heat generator 43. The first protective sheet 41 may be a resinous film with a reduced thickness so as not to disturb heat dissipation from the heat generator 43. The thickness of the first protective sheet 41 is smaller than the second protective sheet 42 so that heat is more transmittable to the first protective sheet 41 than the second protective sheet 42.

As illustrated in FIGS. 5 and 6, the heat generator 43 is entirely provided in a cross-section orthogonal to the A direction of the intake port 4. The heat generator 43 is arranged conforming to the configurations of the inner surface 14d of the outer port member 4b and the inner surface of the inner port member 4c. Specifically, the heat generator 43 is formed in substantially a V-shape as viewed from the Z1 direction. The heat generator 43 is cut (concaved) in a direction opposite to the A direction from an end portion in the A direction.

The heat generator 43 is made of copper extending linearly. The heat generator 43 includes a heating wire 143. The heating wire 143 has a meandering shape as viewed from the Z1 side by folding back and forth alternately. The heating wire 143 includes plural folding-back portions 143a and plural linear portions 143b. The linear portions 143b extend in an R direction (circumferential direction) around a center axis line C2 (see FIG. 1) of the outer port member 4b that extends in an E direction (i.e., extending direction of the outer port member 4b). Each folding-back portion 143a connects the linear portion 143b extending from one side to the other side in the R direction and the linear portion 143b extending from the other side to one side in the R direction or vice versa. The E direction is parallel to the A direction.

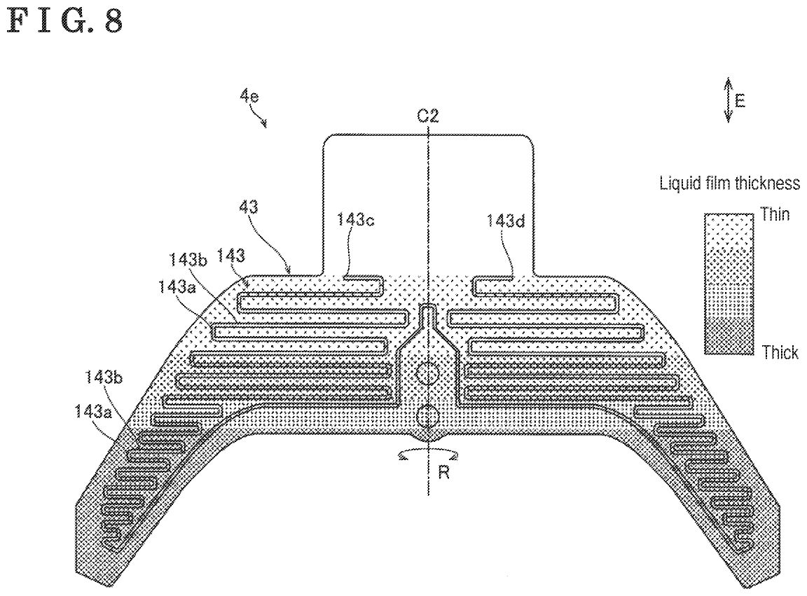

The heating wire 143 includes a first end portion 143c and a second end portion 143d as illustrated in FIG. 8 that are arranged at an opposite side from the end portion of the outer port member 4b. The first end portion 143c and the second end portion 143d are opposed to each other in the R direction. The first end portion 143c and the second end portion 143d of the heating wire 143 are a positive pole and a negative pole respectively. An electric current flows from the first end portion 143c to the second end portion 143d in the heating wire 143 accordingly.

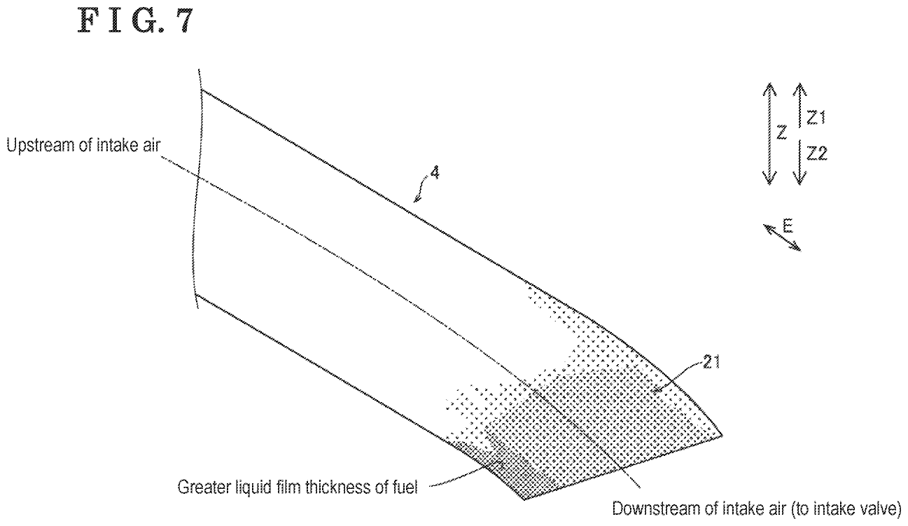

As illustrated in FIG. 7, the fuel 21 injected from the injector 2 is thick at a center and becomes thinner towards an outer side relative to a direction orthogonal to the injection direction. This causes uneven adhesion of the fuel 21 to the inner surface 14d of the outer port member 4b. The fuel 21 is distributed to the inner surface 14d of the outer port member 4b in a manner that the adhesion amount is greater towards the end portion of the outer port member 4b. Specifically, the adhesion amount of the fuel 21 to the inner surface 14d of the outer port member 4b is greatest in the vicinity of the intake valve 13 in the E direction.

As illustrated in FIG. 8, the adhesion amount of the fuel 21 injected from the injector 2 to the port heater 4e is also greater towards an end thereof in the E direction. The thickness of the fuel 21 (liquid film thickness) in the direction orthogonal to the inner surface 14d of the outer port member 4b is greater towards the end side of the port heater 4e in the E direction. Efficient vaporization (evaporation) of the fuel 21 that adheres to the port heater 4e is thus achievable by the heat generation of the port heater 4e that becomes greater towards the end side in the E direction.

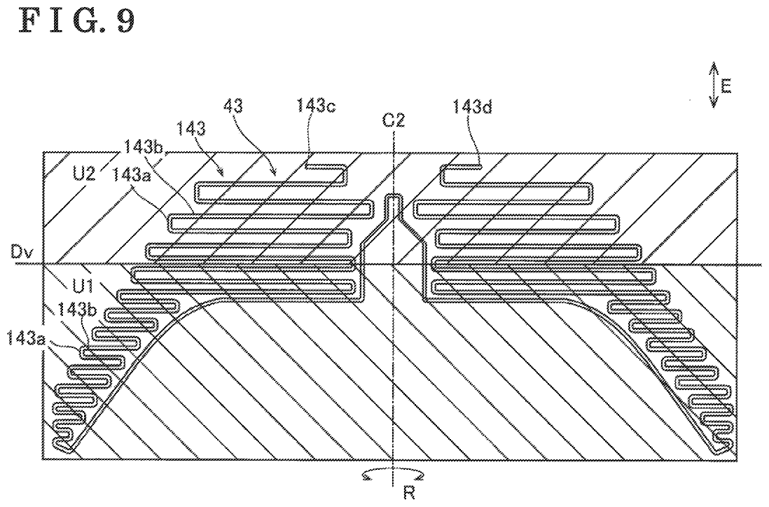

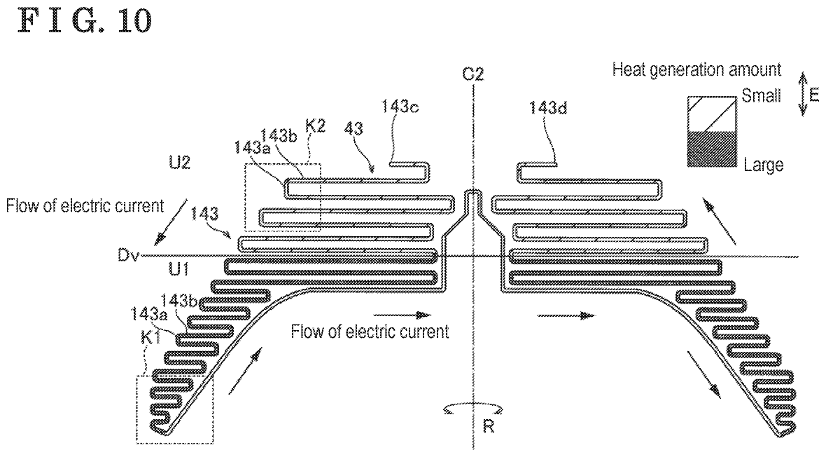

As illustrated in FIGS. 9 and 10, the port heater 4e is constructed to cause unevenness of heat generation in accordance with adhesion distribution of the fuel 21 to the port heater 4e. The port heater 4e is constructed to include areas with different heat generation amounts in accordance with the adhesion distribution of the fuel 21 injected from the injection opening 2a of the injector 2.

Specifically, the port heater 4e includes a first heat generation region U1 and a second heat generation region U2 with different heat generation amounts from each other. The heat generation amount of the first heat generation region U1 is greater than the heat generation amount of the second heat generation region U2. The first heat generation region U1 and the second heat negation region U2 are adjoined to each other via a boundary portion Dv. That is, the first heat generation region U1 and the second heat negation region U2 are specified by dividing the port heater 4e at the boundary portion Dv.

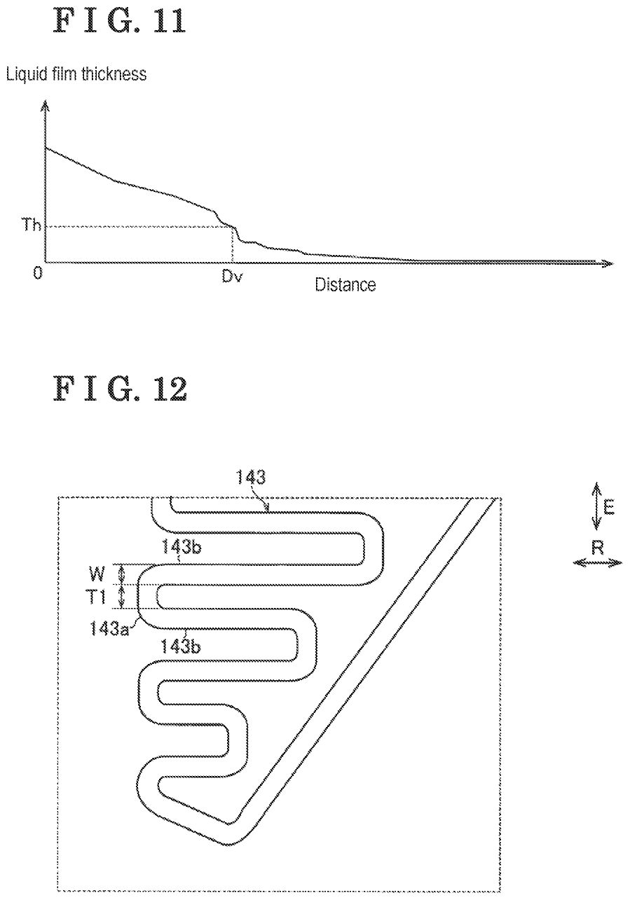

The boundary portion Dv is specified in accordance with the liquid film thickness of the fuel 21 that adheres to the inner surface 14d of the outer port member 4b by referring to a graph as illustrated in FIG. 11, for example. FIG. 11 shows that the liquid film thickness of the fuel 21 that adheres to the inner surface 14d of the outer port member 4b is decreasing towards the upstream side in the A direction away from the end side of the outer port member 4b. The boundary portion Dv may be specified at a position where the liquid film thickness of the fuel 21 greatly decreases, i.e., the position corresponding to a liquid film thickness Th, for example.

As illustrated in FIGS. 10 and 11, the first heat generation region U1 and the second heat generation region U2 are arranged in accordance with the distribution of the fuel 21 injected towards a center of the intake valve 13 from the injection opening 2a of the injector 2 that is provided in an inclined manner.

The first heat generation region U1 with the greater heat generation is specified for an area with the greater adhesion amount of the fuel 21 in the port heater 4e and the second heat generation region U2 with the smaller heat generation is specified for an area with the smaller adhesion amount of the fuel 21 in the port heater 4e. The liquid film thickness of the fuel 21 is greater at the first heat generation region U1 than the second heat generation region U2. The overall length of the heating wire 143 arranged at the first heat generation region U1 is greater than the overall length of the heating wire 143 arranged at the second heat generation region U2. The arrangement of the heating wire 143 is dense at the first heat generation region U1 compared to the second heat generation region U2. The arrangement of the heating wire 143 is sparse at the second heat generation region U2 compared to the first heat generation region U1.

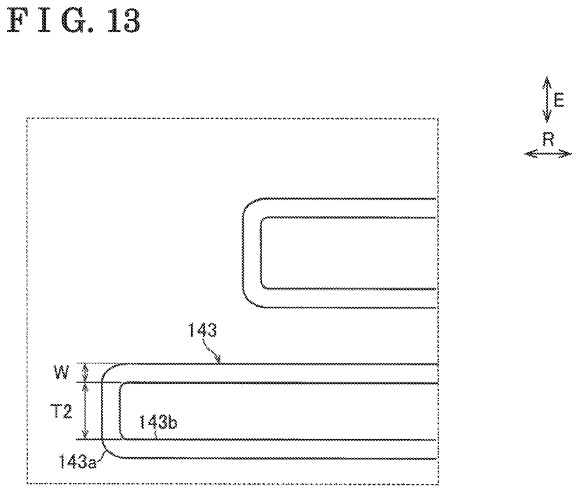

As illustrated in FIGS. 12 and 13, a distance T1 (a first distance) defined by the heating wire 143 folding-back at each of the plural folding-back portions 143a at the first heat generation region U1 is different from a distance T2 (a second distance) defined by the heating wire 143 folding-back at each of the plural folding-back portions 143a at the second heat generation region U2. Specifically, the distance T1 between the adjacent linear portions 143b in the E direction (i.e., extending direction of the outer port member 4b) at the first heat generation region U1 is smaller than the distance T2 between the adjacent linear portions 143b in the E direction at the second heat generation region U2. Respective distances T1 between the plural linear portions 143b at the first heat generation region U1 are the same as one another while respective distances T2 between the plural linear portions 143b at the second heat generation region U2 are the same as one another.

A width W of the linear portion 143b of the heating wire 143 is the same between the first heat generation region U1 and the second heat generation region U2. The width W of the linear portion 143b of the heating wire 143 is smaller than the distance T1 and the distance T2. The heating wire 143 may be easily arranged densely at the first heat generation region U1 because of the width W of the linear portion 143b being smaller than the distance T1.

The heat generation at the first heat generation region U1 and the heat generation at the second heat generation region U2 are different from each other when the same electric current is applied to the first heat generation region U1 and the second heat generation region U2 for entirely heat the port heater 4e.

As illustrated in FIG. 10, the area of the port heater 4e is specified not to increase by an amount corresponding to the sparse arrangement of the heating wire 143. Specifically, the area of the port heater 4e is substantially equal to an area obtained in a case where the respective distances defined by the heating wire 143 folding-back at the plural folding-back portions 143a at the first heat generation region U1 and the second heat generation region U2 are the same.

The number of folding-back portions 143a at the first heat generation region U1 is greater than the number of folding-back portions 143a at the second heat generation region U2. Additionally, the number of plural folding-back portions 143a of the entire port heater 4e is less than the number of plural folding-back portions 143a obtained in a case where the respective distances defined by the heating wire 143 folding-back at the plural folding-back portions 143a at the first heat generation region U1 and the second heat generation region U2 are the same. The entire length of the heating wire 143 of the port heater 4e is shorter than the length obtained in a case where respective distances defined by the heating wire 143 that is folded at the plural folding-back portions 143a at the first heat generation region U1 and the second heat generation region U2 are the same.

The reduction of the entire length of the heating wire 143 of the port heater 4e restrains resistance of the heating wire 143. This enhances flow of electric current applied to the heating wire 143 and increase of temperature thereof. The amount of heat necessary for increasing the temperature of the heating wire 143 to a predetermined value may decrease accordingly.

The heat generator 43 is constituted by the single heating wire 143 including the configuration conforming to the first heat generation region U1 and the configuration conforming to the second heat generation region U2. Specifically, the heat generator 43 is obtained such that the single heating wire 143 is folded multiple times at the first heat generation region U1 and is folded multiple times at the second heat generation region U2.

The temperature of the port heater 4e is controlled by the controller 6 (see FIG. 5) in accordance with a temperature measured by the temperature sensor 5 (see FIG. 5).

The port heater 4e according to the embodiment includes portions (regions) with different heat generation amounts from each other in accordance with the adhesion distribution of the fuel 21 injected from the injection opening 2a of the injector 2 to the inner surface 14d of the outer port member 4b. The heat generation of a portion with less adhesion of the fuel 21 or no fuel adhesion is thus made smaller than the heat generation of a portion with greater adhesion of the fuel 21. Waste of heat generation of the port heater 4e is thus restrained. Additionally, the heat generation at the portion with greater adhesion of the fuel 21 and the heat generation at the portion with less adhesion of the fuel 21 or no fuel are not necessarily equalized to each other for securely vaporizing the fuel 21 adhering to the inner surface 14d of the outer port member 4b. While power consumption of the port heater 4e is restrained, the fuel 21 may be securely vaporized, which leads to increased efficiency of power supplied to the port heater 4e.

The port heater 4e includes the first heat generation region U1 with the greater heat generation for the greater adhesion of the fuel 21 and the second heat generation region U2 with the smaller heat generation for the smaller adhesion of the fuel 21. The port heater 4e thus generates heat in accordance with the distribution of adhesion amount of the fuel 21, which leads to secure vaporization of the fuel 21 while power consumption of the port heater 4e is restrained.

The port heater 4e includes the heating wire 143 including the plural folding-back portions 143a according to the embodiment. The first heat generation region U1 and the second heat generation region U2 are obtainable by a simple construction where the distance T1 and the distance T2 defined by the heating wire 143 folding-back at the plural folding-back portions 143a are differentiated from each other. The construction of the port heater 4e is restrained from being complex accordingly.

The heating wire 143 includes the plural linear portions 143b extending in the R direction (circumferential direction) around the center axis line C2 of the outer port member 4b. The distance T1 between the linear portions 143b in the E direction (extending direction of the outer port member 4b) at the first heat generation region U1 is smaller than the distance T2 between the linear portions 143b at the second heat generation region U2 in the E direction. The heat generation amount of the first heat generation region U1 is thus greater than the second heat generation region U2, which is achievable by a simple structure.

The port heater 4e includes the heat generator 43 constituted by the single heating wire 143 including the configuration conforming to the first heat generation region U1 and the second heat generation region U2. The minimum number of heating wires, i.e., the single heating wire 143, leads to the reduced number of components of the port heater 4e.

The number of plural folding-back portions 143a of the entire port heater 4e according to the embodiment is less than the number of plural folding-back portions 143a obtained in a case where respective distances defined by the heating wire 143 that is folded at the plural folding-back portions 143a at the first heat generation region U1 and the second heat generation region U2 are the same. The second heat generation region U2 is thus easily obtainable.

The embodiment is not limited to include the aforementioned construction and may be appropriately modified or changed.

For example, the heat generator 43 is made of copper extending linearly according to the embodiment. Alternatively, the heat generator 43 may be made of other metal such as nichrome and stainless, for example.

The injector 2 is assembled on the cylinder head 1 according to the embodiment. Alternatively, the injector 2 may be mounted at other portions such as an intake manifold, for example.

The port heater 4e is arranged at the end portion of the outer port member 4b according to the embodiment. Alternatively, the port heater 4e may be arranged at the upstream side than the end portion of the outer port member 4b (for example, at the intake manifold).

The heating wire 143 includes the linear portions 143b extending in the R direction (circumferential direction) around the center axis line C2 of the outer port member 4b in the embodiment. Alternatively, the heating wire 143 may include linear portions extending in parallel to the direction of the center axis line C2 of the outer port member 4b. Further alternatively, the heating wire 143 may be formed into a spiral form.

The port heater 4e includes the first heat generation region U1 at the end portion of the outer port member 4b to which the fuel 21 with greater liquid film thickness adheres and the second heat generation region U2 at the upstream side of the first heat generation region U1 in the A direction. Alternatively, the port heater 4e may include the first heat generation region at a center and the second heat generation region at an outer side when the liquid film thickness of the fuel is smaller at the outer side than the center and the liquid film thickness of the fuel is larger at the center. In a case where the liquid film thickness of the fuel is smaller at the center and is greater at the outer side, the port heater 4e may include the second heat generation region U2 at the center and the first heat generation region U1 at the outer side.

The area of the port heater 4e is substantially equal to an area obtained in a case where the respective distances defined by the heating wire 143 folding-back at the plural folding-back portions 143a at the first heat generation region U1 and the second heat generation region U2 are the same. Alternatively, the area of the port heater 4e may not be equal to that obtained in a case where the respective distances defined by the heating wire 143 folding-back at the plural folding-back portions 143a at the first heat generation region U1 and the second heat generation region U2 are the same.

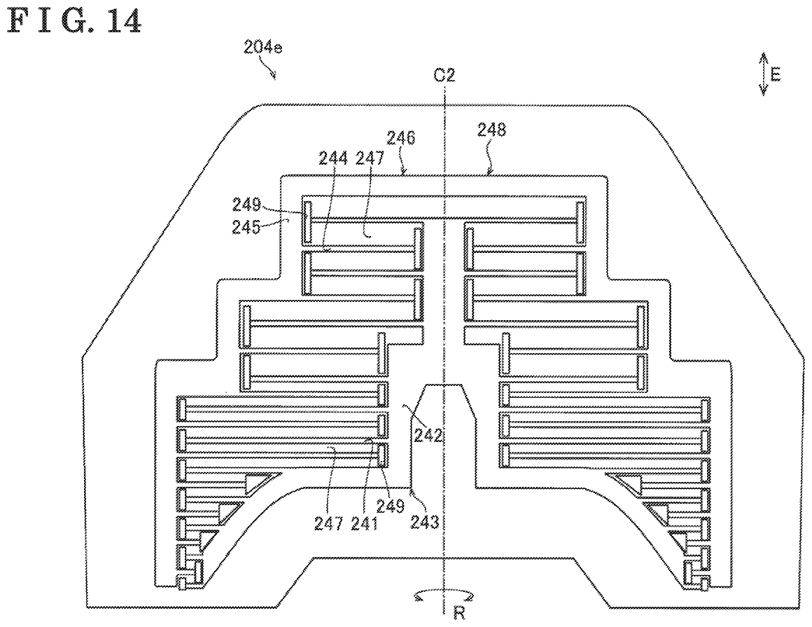

The heat generator 43 is constituted by the heating wire 143 according to the embodiment. Alternatively, the heat generator may be constituted by a heat generation element mainly including carbon (i.e. carbon graphite or carbon nanotube, for example). Specifically, FIG. 14 illustrates a modified example where a port heater 204e includes a first electrode 243, a second electrode 246, and a heat generator 248. The first electrode 243 includes plural comb-shaped electrode portions serving as first comb electrode portions 241 and a first connection electrode portion 242 connecting the first comb electrode portions 241 with one another. The second electrode 246 includes plural comb-shaped electrode portions serving as second comb electrode portions 244 each of which is arranged between the adjacent first comb electrode portions 241, and a second connection electrode portion 245 connecting the second comb electrode portions 244 with one another. The heat generator 248 includes plural heat generating portions 247 generating heat with electric current flowing between the first electrode 243 and the second electrode 246. Respective areas defined between the first electrode 243 (first comb electrode portions 241) and the second electrode 246 (second comb electrode portions 244) at the plural heat generating portions 247 may be differentiated in accordance with distribution of adhesion amount of the fuel 21 injected from the injection opening 2a of the injector 2 to the inner surface 14d of the outer port member 4b. The first heat generation region and the second heat generation region are thus obtainable at the port heater 4e while the construction of the port heater 4e is restrained from being complex. Additionally plural current concentration restraint bores 249 may be desirably provided at the plural heat generation portions 247. Specifically, the current concentration restraint bores 249 are arranged in the vicinity of end portions of the first comb electrode portions 241 and the second comb electrode portions 244 to extend along a direction where the first comb electrode portions 241 and the second comb electrode portions 244 are arranged next to one another.

The port heater 4e includes the first heat generation region U1 and the second heat generation region U2 with different heat generation amounts from each other according to the embodiment. Alternatively, the port heater 4e may include three or more than three heat generation regions with different heat generation amounts from one another so that the heating wire is arranged to be gradually denser.

The intake manifold 3 and the outer port member 4b (port portion) are separately provided according to the embodiment. Alternatively, the intake manifold and the port portion may be integrally provided.

In the embodiment, the number of plural folding-back portions 143a of the entire port heater 4e is less than the number of plural folding-back portions 143a obtained in a case where the respective distances defined by the heating wire 143 folding-back at the plural folding-back portions 143a at the first heat generation region U1 and the second heat generation region U2 are the same. Alternatively, the number of plural folding-back portions 143a of the entire port heater 4e may be smaller or equal to the number of plural folding-back portions 143a obtained in a case where the respective distances defined by the heating wire 143 folding-back at the plural folding-back portions 143a at the first heat generation region U1 and the second heat generation region U2 are the same.

The port heater 4e includes the heat generator 43 that is constituted by the single heating wire 143 including the configuration conforming to the configurations of the first and second heat generation regions U1 and U2. Alternatively, the port heater may include plural heating wires.

According to the embodiment, the intake port 4 (an air intake apparatus of an internal combustion engine) includes the outer port member 4b (a port portion) into which the fuel 21 injected form the injection opening 2a of the injector 2 is introduced, the intake passage 4d provided at an inner side of the outer port member 4b to flow an air-fuel mixture including the fuel 21 and air, the air-fuel mixture being supplied to a cylinder provided at the engine 100, and the port heater 4e provided along the inner surface 14d of the outer port member 4b to vaporize the fuel 21 introduced into the intake passage 4d. The port heater 4e includes regions with different heat generation amounts from each other in accordance with a distribution of an adhesion amount of the fuel 21 injected from the injection opening 2a of the injector 2 to the inner surface 14d of the outer port member 4b.

The port heater 4e includes the first heat generation region U1 and the second heat generation region U2, the first heat generation region U1 generating greater heat than the second heat generation region U2, the first heat generation region U1 to which greater fuel adheres than the second heat generation region U2.

The port heater 4e includes the heating wire 143 including the plural folding-back portions 143a. The heating wire 143 defines the first distance T1 at the first heat generation region U1 by folding-back at each of the plural folding-back portions 143a and the second distance T2 at the second heat generation region U2 by folding-back at each of the plural folding-back portions 143a, the first distance T1 and the second distance T2 being different from each other.

The heating wire 143 includes the plural linear portions 143b extending in the R direction (circumferential direction) of the center axis line C2 of the outer port member 4b, the center axis line C2 extending in a direction where the outer port member 4b extends. The first distance T1 in the extending direction of the outer port member 4b between the adjacent linear portions 143b of the heating wire 143 at the first heat generation portion U1 is smaller than the second distance T2 in the extending direction of the outer port member 4b between the adjacent linear portions 143b of the heating wire 143 at the second heat generation portion U2.

The port heater 4e includes the heat generator 43 constituted by the single heating wire 143 that includes a configuration conforming to configurations of the first heat generation region U1 and the second heat generation region U2.

The number of folding-back portions 143a of the port heater 4e where the first distance T1 and the second distance T2 are different from each other is smaller than the number of folding-back portions 143a of the port heater 4e obtained in a case where the first distance T1 and the second distance T2 are the same as each other.

According to the embodiment, the injector 2 is mounted at the cylinder head 1 while inclining relative to the extending direction of the outer port member 4b. The first heat generation region U1 and the second heat generation region U2 are arranged in accordance with the distribution of the fuel 21 injected towards a center of the intake valve 13 from the injection opening 2a of the injector 2 that is provided in an inclined manner.

In the inner surface 14d of the outer port member 4b, the heat generation of a portion with greater fuel adhesion increases while the heat generation of a portion with less fuel adhesion or no fuel adhesion decreases. Waste of heat generation of the port heater 4e is thus restrained. Power consumption of the port heater 4e is restrained at the time of vaporization of the fuel 21 injected from the injector 2 to adhere to the inner surface 14d of the outer port member 4b.

The port heater 4e is a planar heater according to the embodiment.

The area heated by the port heater 4 is secured, which leads to secure vaporization of the fuel 21 introduced to the outer port member 4b from the injection opening 2a of the injector 2.

The outer port member 4b is provided extending through the inlet port 12 within the cylinder head 1. The port heater 4e is arranged at the portion of the outer port member 4b, the portion being inserted to be positioned within the inlet port 12.

The outer port member 4b is arranged at a portion where the fuel 21 injected towards the combustion chamber 15 from the injection opening 2a of the injector 2 is likely to adhere, which leads to secure vaporization of the fuel 21 adhering to the inner surface 14d of the outer port member 4b.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An air intake apparatus of an internal combustion engine, the air intake apparatus comprising:
a port portion into which fuel injected form an injection opening of an injector is introduced;
an intake passage provided at an inner side of the port portion to flow an air-fuel mixture including the fuel and air, the air-fuel mixture being supplied to a cylinder provided at the internal combustion engine; and
a port heater provided along an inner surface of the port portion to vaporize the fuel introduced into the intake passage,
the port heater including regions with different heat generation amounts from each other in accordance with a distribution of an adhesion amount of the fuel injected from the injection opening of the injector to the inner surface of the port portion.

2. The air intake apparatus according to claim 1, wherein the port heater includes a first heat generation region and a second heat generation region, the first heat generation region generating greater heat than the second heat generation region, the first heat generation region to which greater fuel adheres than the second heat generation region.

3. The air intake apparatus according to claim 2, wherein
the port heater includes a heating wire including a plurality of folding-back portions,
the heating wire defines a first distance at the first heat generation region by folding-back at each of the plurality of folding-back portions and a second distance at the second heat generation region by folding-back at each of the plurality of folding-back portions, the first distance and the second distance being different from each other.

4. The air intake apparatus according to claim 3, wherein
the heating wire includes a plurality of linear portions extending in a circumferential direction of a center axis line of the port portion, the center axis line extending in a direction where the port portion extends,
the first distance in the extending direction of the port portion between the adjacent linear portions of the heating wire at the first heat generation portion is smaller than the second distance in the extending direction of the port portion between the adjacent linear portions of the heating wire at the second heat generation portion.

5. The air intake apparatus according to claim 3, wherein the port heater includes a heat generator constituted by the single heating wire that includes a configuration conforming to configurations of the first heat generation region and the second heat generation region.

6. The air intake apparatus according to claim 3, wherein the number of folding-back portions of the port heater where the first distance and the second distance are different from each other is smaller than the number of folding-back portions of the port heater obtained in a case where the first distance and the second distance are the same as each other.
